(19) United States
(12) Patent Application Publication
(10) Pub. No.: US 2025/0125547 A1
(43) Pub. Date: Apr. 17, 2025

(54) CONNECTOR AND CONNECTOR DEVICE

(71) Applicant: YAZAKI CORPORATION, Tokyo (JP)

(72) Inventor: Akira Shinchi, Makinohara-shi (JP)

(21) Appl. No.: 19/002,747

(22) Filed: Dec. 27, 2024

Related U.S. Application Data
(63) Continuation of application No. PCT/JP2023/040530, filed on Nov. 10, 2023.

(30) Foreign Application Priority Data
Nov. 30, 2022 (JP) 2022-190946

(51) Int. Cl. H01R 12/77; H01R 12/81

(52) U.S. Cl. CPC H01R 12/771; H01R 12/81; H01R 2201/26

(57) ABSTRACT

A first connector includes a first housing provided on a front surface side of a flexible board, and a first cover provided on a back surface side of the flexible board and provided with the flexible board sandwiched between the first housing and the first cover. The first cover includes a plate part with a plate-like shape extending toward the flexible board compared to the first housing. The plate part is configured to be joined to the flexible board.

### CROSS-REFERENCE TO RELATED APPLICATION

This application is a continuation application of International Application No. PCT/JP2023/040530 filed on Nov. 10, 2023 which claims the benefit of priority from Japanese Patent Application No. 2022-190946 filed on Nov. 30, 2022 and designating the U.S., the entire contents of which are incorporated herein by reference.

### BACKGROUND OF THE INVENTION

### 1. Field of the Invention

The present invention relates to a connector and a connector device.

### 2. Description of the Related Art

Conventionally, regarding a connector and a connector device, for example, a connector to be attached to a flexible board as described in Japanese Patent Application Laid-open No. 2004-220864 has been known. In this connector, a terminal is attached to the flexible board, a holding plate is attached to the flexible board, and the terminal is assembled to and held in a housing.

There is room for improvement in the above-mentioned connector in that stress tends to be concentrated in a planar circuit body such as the flexible board. In other words, the connector described above is in a state in which the planar circuit body extends out of the holding plate, and when vibration is applied to the connector, for example, stress tends to be concentrated at a root part of the planar circuit body that extends out of the holding plate.

### SUMMARY OF THE INVENTION

In view of the above, an object of the present invention is to provide a connector and a connector device in which stress concentration on a planar circuit body is reduced.

In order to achieve the above mentioned object, a connector according to one aspect of the present invention includes: a housing provided on a front surface side of a planar circuit body; and a cover disposed on a back surface side of the planar circuit body and provided with the planar circuit body sandwiched between the housing and the cover, wherein one of the cover and the housing includes a plate part with a plate-like shape extending toward the planar circuit body compared to the other, and the plate part is joined to the planar circuit body.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a connector device according to an embodiment;

FIG. 2 is an exploded perspective view of a first connector in the connector device according to the embodiment;

FIG. 3 is an exploded perspective view of the first connector in the connector device according to the embodiment;

FIG. 4 is an exploded perspective view of a second connector in the connector device according to the embodiment;

FIG. 5 is a perspective view of a terminal in the connector device according to the embodiment;

FIG. 6 is an explanatory view for connection of the connector device according to the embodiment;

FIG. 7 is an explanatory view for the connection of the connector device according to the embodiment; and

FIG. 8 is a cross-sectional view of a connection state of the connector device according to the embodiment along VIII-VIII in FIG. 1.

### DETAILED DESCRIPTION OF THE PREFERRED EMBODIMENTS

An embodiment of the present invention will hereinafter be described in detail with reference to the drawings. The present invention is not limited by the present embodiment. Moreover, the component in the embodiment below includes the component that can be substituted or easily conceived by a person skilled in the art or that is substantially the same.

### Embodiment

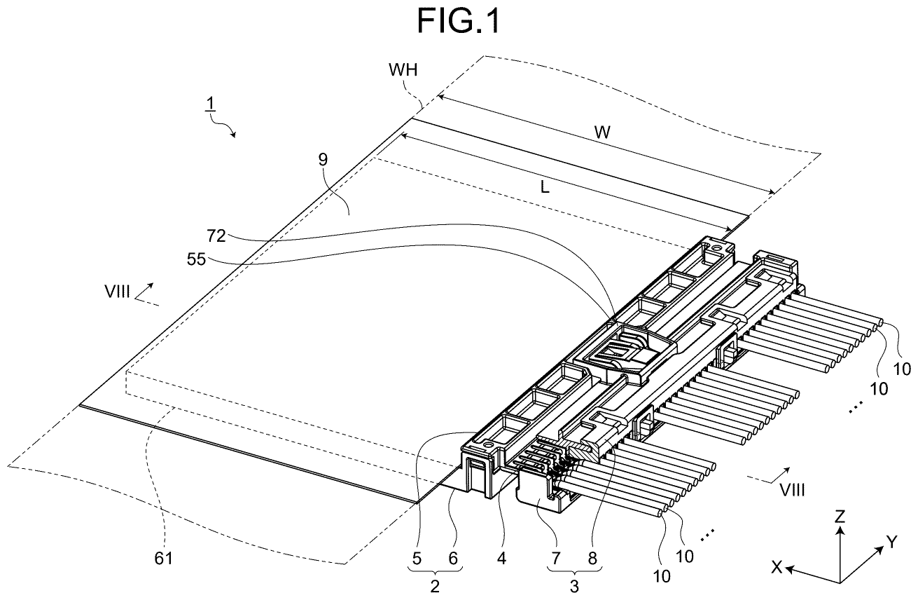

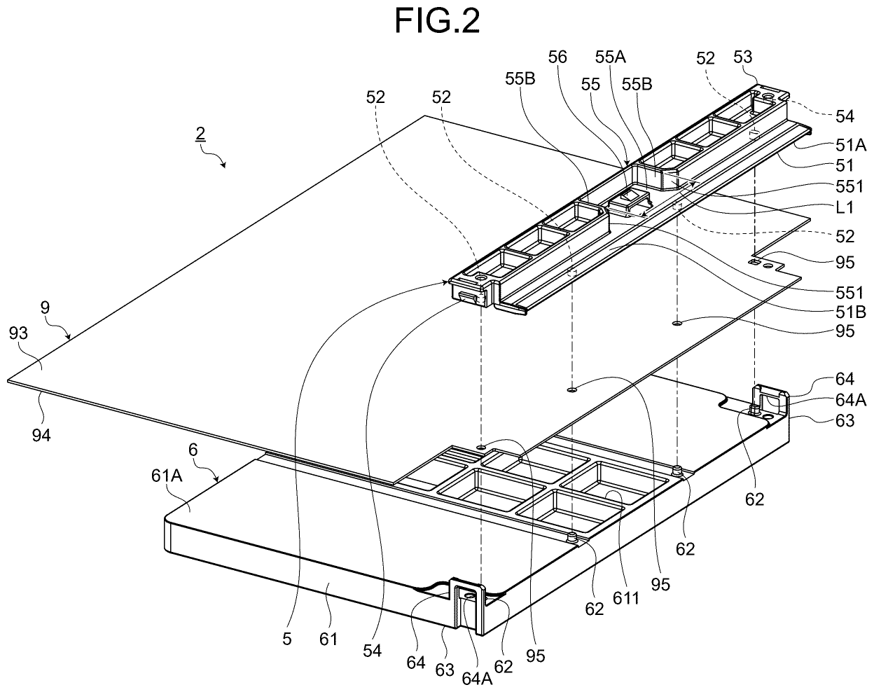

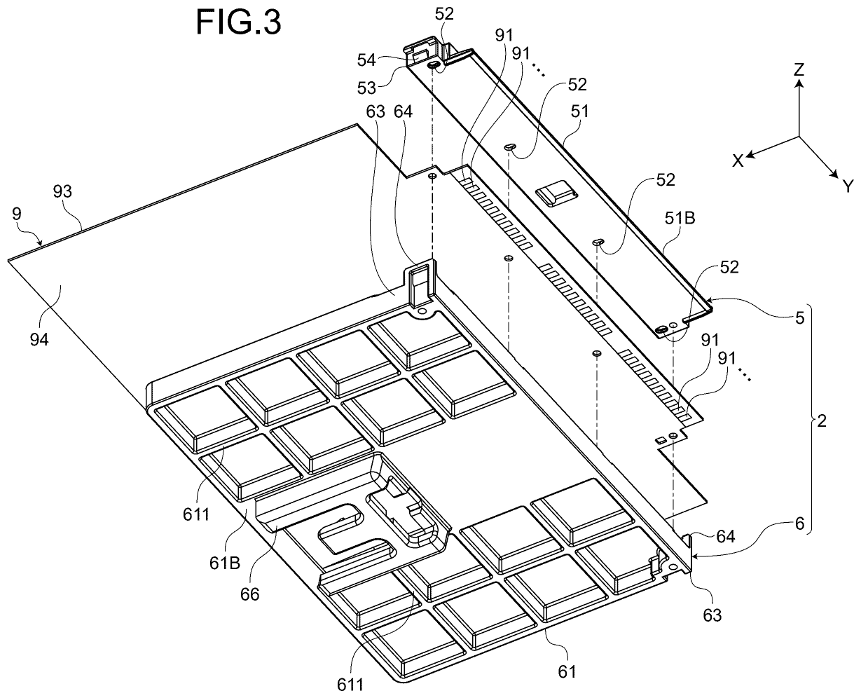

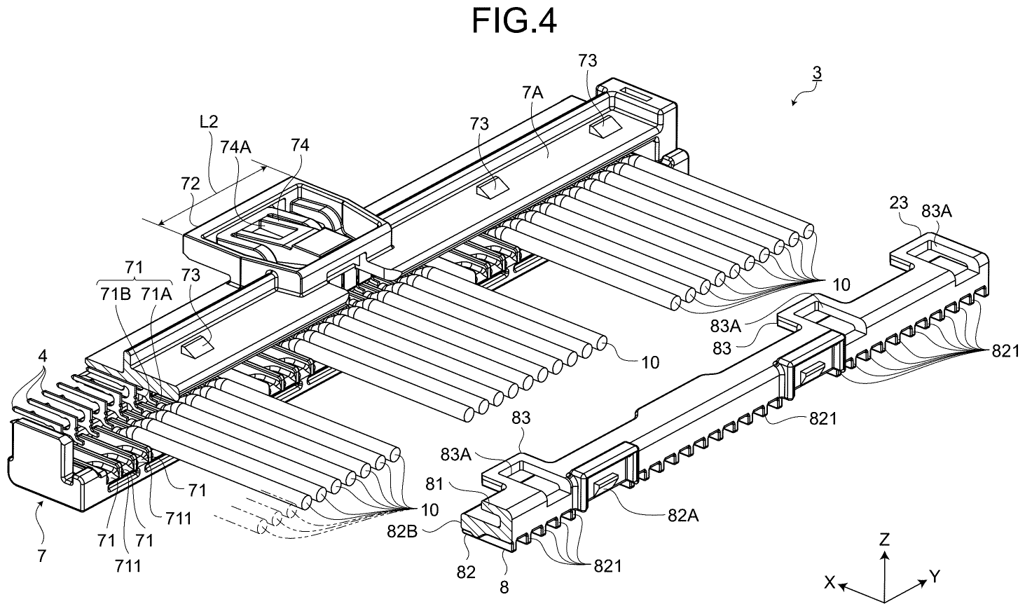

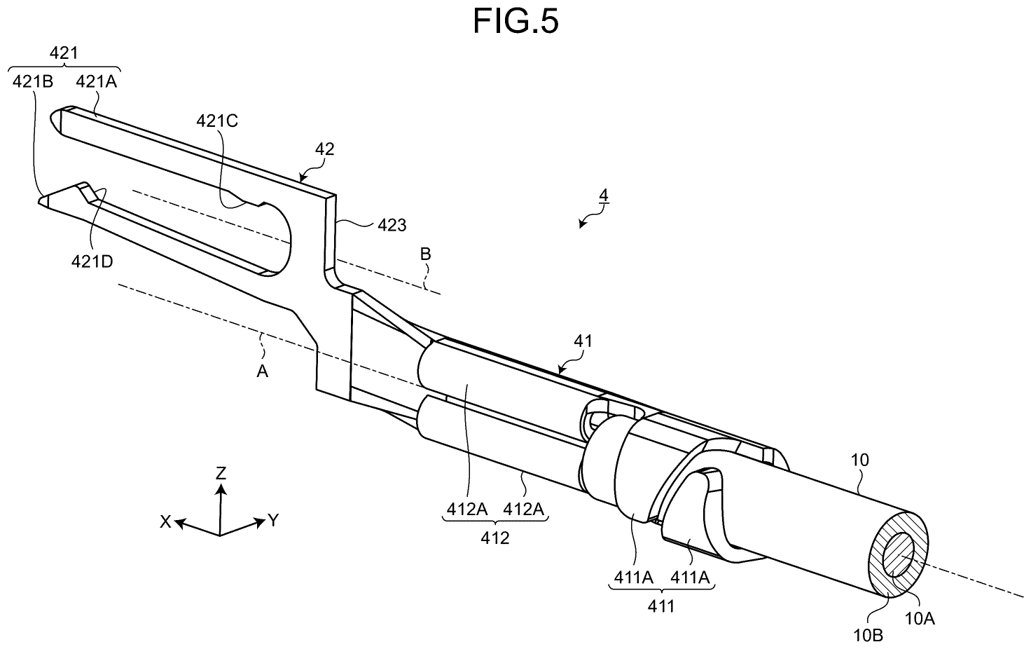

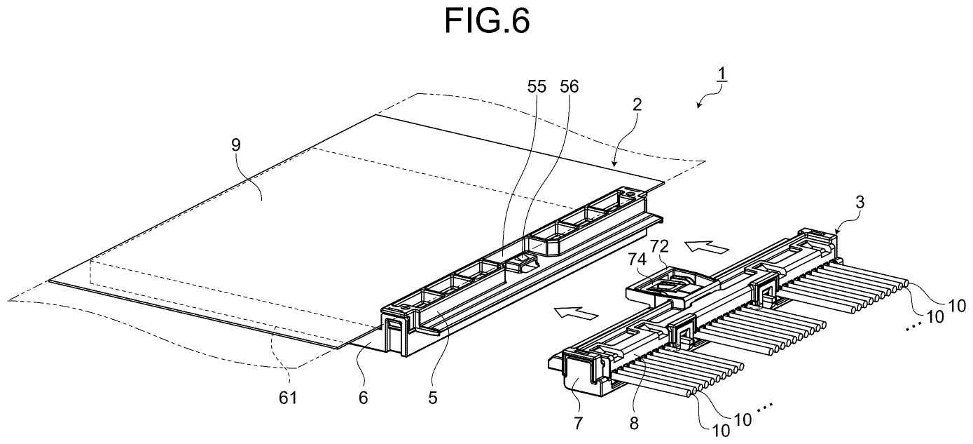

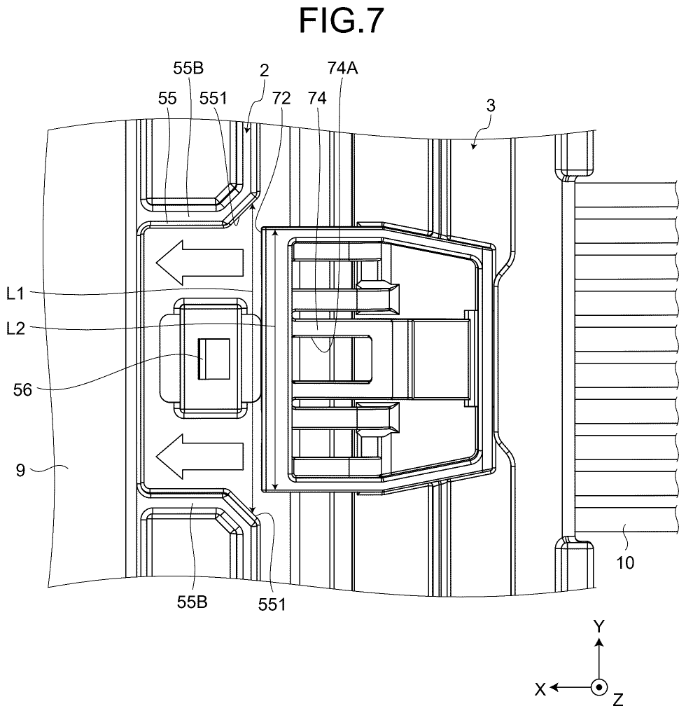

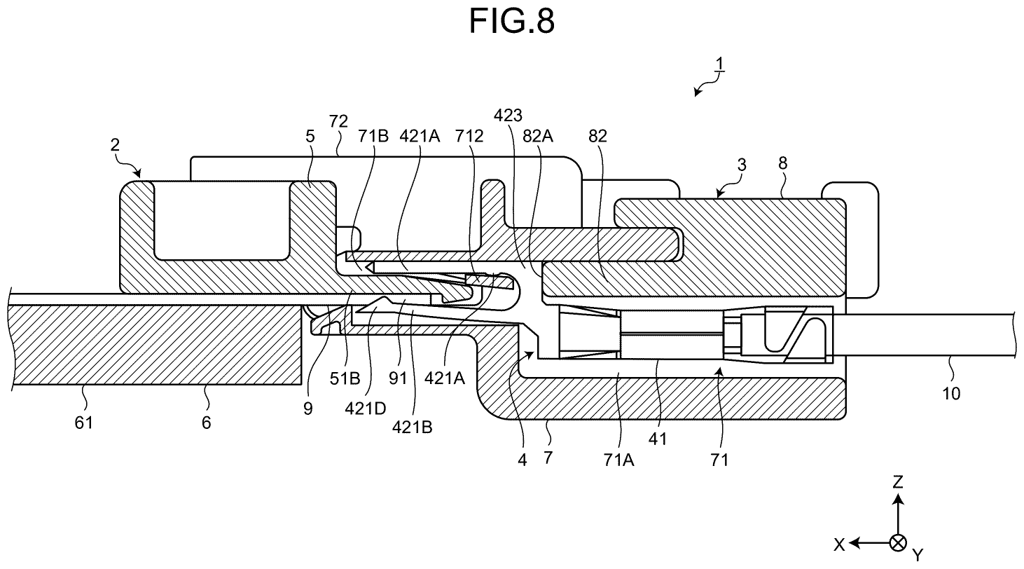

The present embodiment is related to a connector and a connector device. FIG. 1 is a perspective view illustrating a connector device according to an embodiment. FIGS. 2 and 3 are exploded perspective views of a first connector in the connector device according to the embodiment. FIG. 4 is an exploded perspective view of a second connector in the connector device according to the embodiment. FIG. 5 is a perspective view of a terminal in the connector device according to the embodiment. FIG. 6 and FIG. 7 are explanatory views for the connection of the connector device according to the embodiment. FIG. 8 is a cross-sectional view of a connection state of the connector device according to the embodiment along VIII-VIII in FIG. 1.

In the following description, among a first direction, a second direction, and a third direction that intersect with each other, the first direction is referred to as “a connection direction X”, the second direction is referred to as “a width direction Y”, and the third direction is referred to as “a height direction Z”. Here, the connection direction X, the width direction Y, and the height direction Z are mutually orthogonal. The connection direction X corresponds to a direction of connection of the first connector and the second connector or an extension direction of an electric wire. The width direction Y and the height direction Z correspond to intersecting directions that intersect with the connection direction X. Unless otherwise noted, each direction used in the following description shall represent the direction in a state in which the parts are assembled with each other. Note that orthogonal here includes substantially orthogonal.

As illustrated in FIG. 1, a connector device 1 according to the present embodiment is a device that connects a flexible board 9 and an electric wire 10, and is, for example, mounted on a vehicle for use and used as a wire harness WH to connect between electrical devices installed in the vehicle. The electrical devices include electronic control devices, sensors, circuit devices, motors, batteries, etc. For example, the flexible board 9 is used as a trunk line part of the wire harness WH, and the electric wire 10 is used as a branch line part of the wire harness WH.

The connector device 1 includes a first connector 2, a second connector 3, and terminals 4. FIG. 1 illustrates the connector device 1 with the first connector 2 and the second connector 3 connected to each other, and a part of the second connector 3 is cut off in the illustration for convenience of explanation.

The first connector 2 is a connector according to the present embodiment, which is attached to the flexible board 9 and is configured to be connectable to the second connector 3. The flexible board 9 is a planar circuit body with a planar circuit configuration, is called a flexible printed circuit (FPC), and is a printed wiring board with flexibility. The term planar here includes substantially planar. The flexible board 9 is formed by, for example, pasting a base film, a conductor foil, and a coverlay through an adhesive layer. The conductor foil is a wiring pattern of the flexible board 9 and forms wiring parts 91 of the flexible board 9. The flexible board 9 may be a single-sided board with a wiring pattern on only one side of the base film, or may be a double-sided board with wiring patterns on both sides of the base film. The flexible board 9 may or may not have electrical components such as resistors and capacitors mounted for the wiring pattern.

As illustrated in FIG. 2, the first connector 2 has a first housing 5 and a first cover 6, which are attached to, for example, an end part 92 of the flexible board 9. Specifically, the first housing 5 and the first cover 6 are joined together with the flexible board 9 sandwiched therebetween; thus, the first connector 2 is attached to the flexible board 9. The first housing 5 includes a housing main body part 51 with a plate-like shape extending in the width direction Y and is disposed on a front surface 93 side of the flexible board 9. The first housing 5 is a first member provided on the front surface 93 side of the flexible board 9. The first cover 6 is disposed on a back surface 94 side of the flexible board 9 and includes a plate part 61 with a plate-like shape. The first cover 6 is a second member that is disposed on the back surface 94 side of the flexible board 9.

The plate part 61 is a plate body extending toward the flexible board 9 and extends toward the flexible board 9 compared to the first housing 5. The plate part 61 functions as a main body part of the first cover 6 and is formed along the back surface 94 of the flexible board 9. The plate part 61 functions as a member that suppresses deformation of the flexible board 9 and suppresses stress concentration on the flexible board 9. The plate part 61 is formed to be more rigid and less deformable than the flexible board 9. The plate part 61 has, for example, a hollow structure having a rectangular parallelepiped or substantially rectangular parallelepiped shape, and has ribs 611 assembled in a lattice pattern inside.

The plate part 61 is joined to the flexible board 9. For example, the plate part 61 has an installation surface 61A bonded to the flexible board 9 and is integrated with the flexible board 9. The installation surface 61A is a surface of the plate part 61 that faces the flexible board 9 and has the flexible board 9 sandwiched between the installation surface 61A and the first housing 5. Specifically, the plate part 61 is bonded to the flexible board 9 with an adhesive, an adhesive tape, or the like. The plate part 61 may have the entire installation surface 61A bonded to the flexible board 9, or a part of the installation surface 61A may be bonded to the flexible board 9. Note that the plate part 61 and the flexible board 9 may be joined by a method other than bonding, for example, by using piercing or other fasteners, screws, etc.

The plate part 61 extends toward the flexible board 9 compared to the first housing 5, and a length L of the extension is the same length as a length W of the flexible board 9, for example. In FIG. 1, the flexible board 9 is a trunk line part of the wire harness WH and is formed along the width direction Y of the connector device 1. In this case, the length W of the flexible board 9 is the length in the connection direction X, and the length in the direction in which the plate part 61 extends. The same length here includes substantially the same length. The length L of the extension of the plate part 61 is desirably more than or equal to a half of the length W of the flexible board 9. Such a length ensures a smooth connection work between the first connector 2 and the second connector 3. In other words, when connecting the first connector 2 and the second connector 3, a worker holds the second connector 3 with one hand and the first connector 2 with the other hand to perform the connection; in this case, the flexible board 9 will not be deformed when the worker grabs the plate part 61 with the other hand, making it easy to handle the first connector 2. In this case, it is desirable that the length L of the extension of the plate part 61 be the same as the length W of the flexible board 9 in the connection direction X. However, the handling is sufficiently easy as long as the length L of the extension of the plate part 61 is more than or equal to a half of the length W of the flexible board 9.

The installation surface 61A of the first cover 6 includes convex parts 62. The installation surface 61A is a surface of the plate part 61 that faces the flexible board 9 and has the flexible board 9 sandwiched between the installation surface 61A and the first housing 5. The convex part 62 protrudes from the installation surface 61A toward the back surface 94 of the flexible board 9. The protruding length of the convex part 62 is set longer than the thickness of the flexible board 9. The multiple convex parts 62 are provided; for example, one is provided at each of end parts 63 of the first cover 6 in the width direction Y, and two are provided at an intermediate position between the end parts 63 and 63, which are a total of four. The flexible board 9 includes penetration holes 95. The penetration hole 95 is a hole penetrating the front surface 93 and the back surface 94. The multiple penetration holes 95 are formed at positions corresponding to the convex parts 62. An installation surface 51A of the first housing 5 includes concave parts 52. The installation surface 51A is a surface of the housing main body part 51 that faces the flexible board 9 and has the flexible board 9 sandwiched between the installation surface 51A and the first cover 6. The concave part 52 is formed by depressing the installation surface 51A and is large enough to allow insertion of the convex part 62. The multiple concave parts 52 are formed at positions corresponding to the convex parts 62.

The end part 63 of the first cover 6 includes an engaging part 64, and an end part 53 of the first housing 5 includes an engaged part 54. The engaging part 64 and the engaged part 54 constitute a locking mechanism that latches the first cover 6 and the first housing 5. For example, the engaged part 54 is a projection protruding laterally from a side surface of the first housing 5, and the engaging part 64 extends from the end part 63 of the first cover 6 to the first housing 5 side to form a hole 64A into which the engaged part 54 can be inserted.

To attach the first cover 6 and the first housing 5 to the flexible board 9, first, the first cover 6 is placed on the back surface 94 of the flexible board 9 and the convex parts 62 are inserted through the penetration holes 95. The convex parts 62 protrude from the front surface 93 through the penetration holes 95. At this time, the flexible board 9 and the plate part 61 of the first cover 6 are joined together by adhesion or the like for integration. Accordingly, the flexible board 9 is kept so as not to be deformed.

The convex parts 62 protruding from the front surface 93 of the flexible board 9 are inserted into the concave parts 52, and the first housing 5 is installed. Thus, the first cover 6 and the first housing 5 are installed at the correct positions with respect to the flexible board 9. In other words, in the flexible board 9, the first cover 6, and the first housing 5, the penetration holes 95, the convex parts 62, and the concave parts 52 function as portions for positioning and function as portions for suppressing the detachment of the flexible board 9 from between the first cover 6 and the first housing 5.

Then, the engaging part 64 of the first cover 6 is engaged with the engaged part 54 of the first housing 5; thus, the first housing 5 and the first cover 6 are joined together so that they will not be easily detached. As a result, the first cover 6 and the first housing 5 are joined together with the flexible board 9 sandwiched therebetween, and the first cover 6 and the first housing 5 are attached to the flexible board 9.

The first housing 5 includes an accommodation part 55. The accommodation part 55 is a portion into which a protrusion part 72 of the second connector 3 is inserted, and defines an accommodation space 55A for the protrusion part 72. For example, the accommodation part 55 is formed by a wall part 55B provided in the housing main body part 51. The wall part 55B is provided along the connection direction X with an opening on the second connector 3 side (lower right side in FIG. 2). The length of the accommodation space 55A in the width direction Y is the same or substantially the same as the length of the protrusion part 72 in the width direction Y. When the protrusion part 72 is inserted into the accommodation part 55, the first connector 2 and the second connector 3 are correctly connected, thereby bringing the terminal 4 into contact with the desired wiring part 91. The length of the accommodation space 55A in the connection direction X is of such a degree that the oblique connection between the first connector 2 and the second connector 3 can be suppressed. Therefore, the connector device 1 can suppress the oblique fitting and connection between the first connector 2 and the second connector 3.

The accommodation part 55 includes a tapered part 551. The tapered part 551 is formed with the wall part 55B inclined to the connection direction X so that a length L1 of the accommodation part 55 in the width direction Y becomes larger than a length L2 of the protrusion part 72 in the width direction Y at an entrance position of the accommodation part 55. In other words, the tapered part 551 functions as a portion that facilitates the insertion of the protrusion part 72 into the accommodation part 55. For example, the tapered part 551 is formed so that the length L1 of the accommodation space 55A in the width direction Y becomes larger than the length L2 of the protrusion part 72 in the width direction Y at an entrance part of the accommodation part 55, and the length L1 of the accommodation space 55A in the width direction Y becomes smaller than the length L2 of the protrusion part 72 in the width direction Y toward the deeper side in the accommodation part 55. This tapered part 551 is formed, for example, at the entrance part of the accommodation part 55, at each of the left and right positions in the width direction Y. In the connector device 1, the formation of the tapered part 551 makes it easier to insert the protrusion part 72 into the accommodation part 55 and smoothly connect the first connector 2 and the second connector 3 to each other. In particular, the first connector 2 and the second connector 3 are easily connected even when the clearance between the accommodation space 55A of the accommodation part 55 and the protrusion part 72 is small.

One accommodation part 55 is formed, for example, at a center position of the first housing 5 in the width direction Y. A plurality of the accommodation parts 55 may be formed, which may be spaced apart in the width direction Y of the first housing 5. The accommodation part 55 includes a latched part 56. The latched part 56 is a portion that is engaged with a latching part 74 of the second connector 3, and is used to latch when the first connector 2 and the second connector 3 are connected. The latched part 56 is, for example, a projection protruding toward the height direction Z, is latched by the latching part 74, and functions as a locking mechanism for the first connector 2 and the second connector 3.

As illustrated in FIG. 3, the plate part 61 includes an attachment part 66. The attachment part 66 is a portion used to attach the connector device 1 to a structure such as a vehicle body of a vehicle. For example, the attachment part 66 functions as an attachment clip or an attachment clamp to fix the connector device 1. The attachment part 66 is formed on a back surface 61B of the plate part 61.

The wiring parts 91 are formed on the flexible board 9. The wiring part 91 is a portion to serve as a contact point for electrical connection of the flexible board 9 and is a part of the wiring pattern. At the position of the wiring part 91, the coverlay for surface protection has been removed, leaving the conductor foil exposed. The wiring part 91 is also subjected to surface treatment to prevent oxidation of the conductor foil, for example. The multiple wiring parts 91 are, for example, arranged along the width direction Y at the end part 92 of the back surface 94 of the flexible board 9. The number of wiring parts 91 is set according to the number of terminals 4 of the second connector 3, for example. The end part 92 of the flexible board 9 on which the wiring parts 91 are formed is disposed adjacent to a connection insertion part 51B of the first housing 5. The connection insertion part 51B is a plate-like part of the housing main body part 51 of the first housing 5 that protrudes to the second connector 3 side along the connection direction X.

As illustrated in FIG. 4, the second connector 3 is a connector that is connected to the first connector 2 and makes the terminals 4 electrically connect to the wiring parts 91 of the flexible board 9. In other words, the second connector 3 holds the terminals 4, is configured to be connectable to the first connector 2, and brings the terminals 4 into direct contact and connection with the wiring parts 91 of the flexible board 9 by connecting to the first connector 2.

The second connector 3 includes a second housing 7 and a second cover 8. FIG. 4 illustrates the second housing 7 and the second cover 8 that are partially cut off for convenience of explanation, and the illustration of a part of the electric wires 10 is omitted. The second housing 7 is a member that holds the terminals 4 attached to the electric wires 10, and the second cover 8 is a member that is attached to the second housing 7 and holds the electric wires 10 while suppressing the detachment of the terminals 4.

The second housing 7 is a member that holds the terminals 4 attached to the electric wires 10, and is formed in a block-like shape, for example. The second housing 7 forms accommodation chambers 71 that accommodate the terminals 4 and the electric wires 10, and holds the terminals 4 together with the second cover 8. The second connector 3 can hold the terminals 4, and the second housing 7 has the accommodation chambers 71 side by side arranged along the width direction Y. The accommodation chamber 71 extends along the connection direction X and can accommodate the terminal 4 and the electric wire 10. This accommodation chamber 71 includes a first accommodation chamber 71A and a second accommodation chamber 71B. The first accommodation chamber 71A is a space for accommodating the electric wire 10, and the second accommodation chamber 71B is a space for accommodating the terminal 4. The second accommodation chamber 71B is formed on the first connector 2 side relative to the first accommodation chamber 71A. The second accommodation chamber 71B is narrower than the first accommodation chamber 71A in the width direction Y. Therefore, the terminal 4 accommodated in the second accommodation chamber 71B is held in such a manner that the movement is restricted in the second accommodation chamber 71B. In other words, the terminal 4 is positioned and held with respect to the second connector 3 in the width direction Y and the height direction Z by being accommodated in the second accommodation chamber 71B.

The second accommodation chamber 71B includes a supporting part 712 (see FIG. 8). The supporting part 712 is a portion that supports a first contact piece 421A of the terminal 4, which will be described below. The supporting part 712 is spaced apart from an inner surface of the second accommodation chamber 71B.

Both end parts of the accommodation chamber 71 in the connection direction X are released and open. The connection insertion part 51B of the first connector 2 and the end part 92 of the flexible board 9 can be inserted into an end part of the accommodation chamber 71 on the first connector 2 side. At an end part of the accommodation chamber 71 on the opposite side of the first connector 2, the electric wire 10 extends. The second housing 7 has a partition part 711 formed between the adjacent accommodation chambers 71, so that the terminals 4 placed adjacent to each other will not short-circuit.

A top surface 75A of a ceiling part 75 of the second housing 7 includes the protrusion part 72 and latched parts 73. The protrusion part 72 is a portion with a block-like or plate-like shape protruding to the first connector 2 side and, together with the accommodation part 55 of the first connector 2, constitutes a connection guide part or an oblique connection suppression part. In other words, the protrusion part 72 is formed to have the size that can be inserted into the accommodation part 55, and is inserted into the accommodation part 55 when the first connector 2 and the second connector 3 are connected. This allows the protrusion part 72 to suppress the oblique fitting of the first connector 2 and the second connector 3 and to properly connect the first connector 2 and the second connector 3 to each other. The protrusion part 72 includes the latching part 74. The latching part 74 is a portion used to latch when connecting the first connector 2 and the second connector 3, and together with the latched part 56 of the first connector 2, the latching part 74 constitutes a locking mechanism. The latching part 74 is an arm-shaped portion including a latching hole 74A that can latch in the latched part 56 with a projecting shape, and engages with the latched part 56 when the first connector 2 and the second connector 3 are connected. The latched part 73 is a portion that engages with a latching part 83 of the second cover 8, and together with the latching part 83, the latched part 73 constitutes a locking mechanism for the second housing 7 and the second cover 8. The latched part 73 is a projection protruding from the top surface 75A. The multiple latched parts 73, for example, three latched parts 73, are provided apart from each other in the width direction Y.

The second cover 8 is attached to the second housing 7 from the connection direction X and holds the terminals 4 and the electric wires 10. For example, the second cover 8 is a plate-shaped member extending in the width direction Y, is attached to the second housing 7 in which the terminals 4 and the electric wires 10 are accommodated, and holds the terminals 4 and the electric wires 10. The second cover 8 has a ceiling part 81 and a contact part 82. The ceiling part 81 and the contact part 82 extend side by side in the connection direction X and are spaced apart in the height direction Z. The ceiling part 81 and the contact part 82 are coupled together on the opposite side of the connection side of the first connector 2, with the ceiling part 81 located above the contact part 82. The second cover 8 is attached to the second housing 7 so that the ceiling part 75 of the second housing 7 is sandwiched between the ceiling part 81 and the contact part 82.

The ceiling part 81 includes the latching part 83. The latching part 83 is a portion that engages with the latched part 73 of the second housing 7. The latching part 83 extends from the ceiling part 81 to the second housing 7 side along the connection direction X to form an arm-like shape, and forms an engagement hole 83A that latches the latched part 73. A plurality of the latching parts 83, for example three latching parts 83, are provided apart from each other in the width direction Y. The latching part 83 engages with the latched part 73 when the second cover 8 and the second housing 7 are attached, thereby locking the second cover 8 and the second housing 7 so that they will not be detached.

As illustrated in FIG. 5, the terminal 4 is a terminal attached to the electric wire 10 and is, for example, a crimp terminal that is crimped and attached to an end part of the electric wire 10. The terminal 4 includes an electric wire connection part 41 and a board connection part 42. The terminal 4 is formed of conductive metal, for example, and a plate material with a shape corresponding to the electric wire connection part 41 and the board connection part 42 is pressed or bent so that the electric wire connection part 41 and the board connection part 42 are formed integrally. The terminal 4 is formed by a series of the electric wire connection part 41 and the board connection part 42 along the connection direction X. The electric wire 10 is, for example, a conductor 10A with a coating part 10B provided at its outer circumference.

The electric wire connection part 41 includes, for example, a coating crimp part 411 and a conductor crimp part 412. The coating crimp part 411 crimps the coating part 10B of the electric wire 10. For example, the coating crimp part 411 includes two barrels 411A, which are attached to the coating part 10B in such a way that the barrels 411A are wound and crimped around the coating part 10B. For example, the conductor crimp part 412 includes two barrels 412A, which are attached to the conductor 10A in such a way that the barrels 412A are fastened and crimped on the conductor 10A exposed by removing the coating part 10B.

The board connection part 42 is a portion that is in contact with the flexible board 9 and includes a pair of contact pieces 421. The pair of contact pieces 421 is composed of a first contact piece 421A and a second contact piece 421B. In the board connection part 42, for example, the second contact piece 421B is brought into direct contact with the flexible board 9, thereby making a connection with the flexible board 9. The first contact piece 421A and the second contact piece 421B are plate-like or rod-like bodies extending in the connection direction X, are spaced apart in the height direction Z, and are coupled together at their base end sides by a coupling part 423. In other words, the board connection part 42 including the pair of contact pieces 421 forms a tuning fork terminal part with a two-way shape. The second contact piece 421B is formed to be elastically deformable by bending in a direction away from the first contact piece 421A (height direction Z). At the time of connection to the first connector 2, the flexible board 9 is inserted between the first contact piece 421A and the second contact piece 421B. At the time of this insertion, the second contact piece 421B elastically deforms in the direction away from the first contact piece 421A, allowing the flexible board 9 to be inserted smoothly. The second contact piece 421B is then strongly brought into contact with the flexible board 9 by the restoring force of the elastic deformation. In this case, the first contact piece 421A functions as a load receiving part to receive the contact load of the second contact piece 421B.

An axial direction B of the board connection part 42 is displaced in the height direction Z with respect to an axial direction A of the electric wire connection part 41. That is to say, the axial direction B in which the board connection part 42 extends is deviated in a direction that intersects with the axial direction A with respect to the axial direction A in which the electric wire connection part 41 extends. Therefore, the board connection part 42 is formed by protruding in a direction intersecting the axial direction A (height direction Z) with respect to the electric wire connection part 41. Here, the axial direction A of the electric wire connection part 41 is a central axial line of the electric wire connection part 41, and the axial direction B of the board connection part 42 is a central axial line of the board connection part 42. For example, the board connection part 42 is formed so as to protrude to a position at which the axial direction B deviates from the electric wire connection part 41.

The first contact piece 421A includes a convex part 421C protruding to the second contact piece 421B side. In other words, the convex part 421C protrudes inward compared to the rest of the first contact piece 421A, narrowing the distance between the first contact piece 421A and the second contact piece 421B. The convex part 421C is formed, for example, at a position on the base end side of the first contact piece 421A relative to the center position in the connection direction X.

A contact part 421D is formed at a tip end of the second contact piece 421B. The contact part 421D protrudes to the first contact piece 421A side compared to the rest of the second contact piece 421B, narrowing the distance between the first contact piece 421A and the second contact piece 421B. The contact part 421D is a portion that is in contact with the wiring part 91 of the flexible board 9, and has, for example, a mountain-like shape toward the first contact piece 421A. Although FIG. 5 illustrates the terminal 4 that is attached to the electric wire 10 by crimping, the terminal 4 may be attached to the electric wire 10 by a method other than crimping, such as pressure welding or soldering.

Next, the connection of the connector device 1 according to this embodiment will be described.

As illustrated in FIG. 6, the connection of the connector device 1 is made by connecting the first connector 2 and the second connector 3. The flexible board 9 is attached to the first connector 2, and the second connector 3 holds the terminals 4 attached to the electric wires 10.

The first connector 2 and the second connector 3 are disposed apart from each other with respect to the connection direction X. Then, for example, the second connector 3 is brought closer to the first connector 2 and thus, the connection is made. At this time, the formation of the plate part 61 in the first cover 6 of the first connector 2 makes the connection easy and smooth. For example, when connecting the first connector 2 and the second connector 3, a worker holds the second connector 3 with one hand and the first connector 2 with the other hand to make the connection. In this case, when the plate part 61 is held by the other hand, the flexible board 9 will not be deformed, making it easy to handle the first connector 2. Accordingly, the first connector 2 and the second connector 3 are connected easily and smoothly. For example, if the first cover 6 does not include the plate part 61, the worker cannot hold an easily deformable part of the flexible board 9 with the other hand, and has no choice but to hold the first housing 5, which is shorter in the connection direction X. In this case, the connection work is not easy. In contrast to this, in the connector device 1 according to the present embodiment, the first connector 2 includes the plate part 61; therefore, the part of the flexible board 9 can be held together with the plate part 61 and accordingly, the first connector 2 and the second connector 3 can be connected to each other easily and smoothly.

At the connection between the first connector 2 and the second connector 3, first, the protrusion part 72 of the second connector 3 is inserted into the accommodation part 55 of the first connector 2. As illustrated in FIG. 7, the tapered part 551 is formed at the entrance part of the accommodation part 55, and the opening width of the accommodation part 55 is wide. Therefore, the protrusion part 72 is smoothly inserted into the accommodation part 55 by the tapered part 551.

The protrusion part 72 enters in the connection direction X along the wall part 55B of the accommodation part 55. Thus, the oblique insertion of the second connector 3 into the first connector 2 is suppressed, and the oblique fitting between the second connector 3 and the first connector 2 is suppressed. When the protrusion part 72 is inserted to the depth of the accommodation part 55, the latching part 74 is engaged with the latched part 56, and the first connector 2 and the second connector 3 are connected and locked.

As illustrated in FIG. 8, by the connection between the first connector 2 and the second connector 3, the connection insertion part 51B of the first connector 2 and the flexible board 9 are inserted into the second housing 7 of the second connector 3. In other words, the connection insertion part 51B and the flexible board 9 are inserted into the accommodation chamber 71 of the second housing 7 and inserted between the first contact piece 421A and the second contact piece 421B of the terminal 4 held in the accommodation chamber 71. At this time, by the insertion of the connection insertion part 51B, the space between the first contact piece 421A and the second contact piece 421B is widened, and the second contact piece 421B bends away from the first contact piece 421A. This allows the connection insertion part 51B and the flexible board 9 to be smoothly inserted between the first contact piece 421A and the second contact piece 421B.

The first contact piece 421A is then pressed against, and gets in contact with the wiring part 91 of the flexible board 9, thereby connecting the flexible board 9 and the terminal 4 and electrically connecting the flexible board 9 and the electric wire 10. This allows the flexible board 9 and the electric wire 10 to be connected to each other through one terminal 4, enhancing the electrical performance of the flexible board 9 and the electric wire 10. In other words, by using the flexible board 9 as a contact point, the installation of the terminal can be omitted in the first connector 2, and two physical contact points can be obtained in the connection between the electric wire 10 and the flexible board 9. Therefore, the connector device 1 can reduce the risk of increased resistance and poor connection due to oxidation, wear, foreign matters, and the like at the contact points, and improve the electrical performance of the flexible board 9 and the electric wire 10. In addition, the connector device 1 can omit the installation of the terminal in the first connector 2, thus reducing the cost of the connector device 1.

As illustrated in FIG. 1, the connector device 1 is attached to a vehicle with the first connector 2 and the second connector 3 connected. For example, as illustrated in FIG. 3, the connector device 1 is fixed to a vehicle body of the vehicle or the like using the attachment part 66 provided in the plate part 61. Accordingly, the flexible board 9, the first connector 2, and the connector device 1 can be stably attached to the vehicle.

In FIG. 1, in the case where the connector device 1 is attached to a vehicle, even if vibration or shaking is applied to the connector device 1, stress concentration on the flexible board 9 is suppressed. In other words, a part of the flexible board 9 that extends from the first housing 5 and the first cover 6 is integrated with the plate part 61. Thus, the support by the plate part 61 is obtained and the deformation due to shaking in an up-down direction is restricted. Therefore, the stress concentration on the flexible board 9 is suppressed.

As described above, the connector device 1 and the first connector 2 according to the present embodiment can suppress the stress concentration on the flexible board 9 by providing the plate part 61 in the first cover 6.

The connector device 1 and the first connector 2 according to the present embodiment can be stably attached to a vehicle, including the flexible board 9, by providing the attachment part 66 in the plate part 61.

In the connector device 1 and the first connector 2 according to the present embodiment, the plate part 61 is joined to the flexible board 9 by adhesion, thereby joining the plate part 61 to the flexible board 9 for sure for integration.

The connector and the connector device according to the present invention are not limited to the embodiment described above, and various changes are possible within the scope of claims. The connector device 1 and the first connector 2 according to the present embodiment may be configured by combining the components of each of the embodiments and modifications described above as appropriate.

For example, the connector device 1 and the first connector 2 according to the embodiment described above are mounted on a vehicle; however, the connector device 1 and the first connector 2 may alternatively be used without being mounted on a vehicle.

The connector device 1 and the first connector 2 according to the embodiment described above employ the flexible board 9 as the planar circuit body; however, a planar circuit body other than the flexible board 9 may alternatively be used. For example, a flat cable (FC), a flexible flat cable (FFC), or the like may be used as the planar circuit body and connected to the terminals 4. Even such a connector device can have the operation effect similar to that of the connector device 1 and the first connector 2 according to the embodiment described above. In other words, the connector device and the connector can suppress the stress concentration on the flexible board 9 by providing the plate part 61 in the first cover 6.

In the connector device 1 and the first connector 2 according to the embodiment described above, the plate part 61 is provided in the first cover 6; however, the plate part 61 may be provided in the first housing 5. Even in this case, the operation effect similar to that of the connector device 1 and the first connector 2 according to the embodiment described above can be obtained, and the stress concentration on the flexible board 9 can be suppressed.

By the connector and the connector device according to the present embodiment, stress concentration on the planar circuit body can be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a housing provided on a front surface side of a planar circuit body; and
a cover disposed on a back surface side of the planar circuit body and provided with the planar circuit body sandwiched between the housing and the cover, wherein
one of the cover and the housing includes a plate part with a plate-like shape extending toward the planar circuit body compared to the other, and
the plate part extends toward the planar circuit body from a position sandwiched between the housing and the cover, and is joined to the planar circuit body.

2. The connector according to claim 1, wherein
the connector is mounted on a vehicle for use, and
the plate part forms an attachment part that is used for attachment to the vehicle.

3. The connector according to claim 1, wherein
the plate part is joined to the planar circuit body by adhesion.

4. The connector according to claim 2, wherein
the plate part is joined to the planar circuit body by adhesion.

5. The connector according to claim 1, wherein
the planar circuit body is a flexible board.

6. The connector according to claim 2, wherein
the planar circuit body is a flexible board.

7. A connector device comprising:
a first connector that is attached to a planar circuit body; and
a second connector that holds a terminal attached to an electric wire, is configured to be connectable to the first connector, and brings the terminal in contact with the planar circuit body by connecting to the first connector, wherein
the first connector includes a first member provided on a front surface side of the planar circuit body, and a second member disposed on a back surface side of the planar circuit body and provided with the planar circuit body sandwiched between the first member and the second member,
one of the first member and the second member forms a plate part with a plate-like shape extending toward the planar circuit body compared to the other of the first member and the second member, and
the plate part extends toward the planar circuit body from a position where it is attached to the first connector, and is joined to the planar circuit body.
